(19) United States
(12) Patent Application Publication
(10) Pub. No.: US 2006/0121352 A1
(43) Pub. Date: Jun. 8, 2006

(54) Cathode compositions and method for lithium-ion cell construction having a lithum compound additive, eliminating irreversible capacity loss

(76) Inventors: Joseph B Kejha, Meadowbrook, PA (US); W Novis Smith, Philadelphia, PA (US)

Correspondence Address: Zachary T Wobensmith III, 7746 101st Court, Vero Beach, FL, 32967-2871, US

(21) Appl. No.: 10/534,313

(22) PCT Filed: Nov. 18, 2002
(86) PCT No.: PCT/US02/36878

§ 371 Date: May 9, 2005

(51) Int. Cl. H01M 4/62; H01M 4/52

(52) U.S. Cl. 429/232; 252/182.1; 429/217; 429/231.3

(57) ABSTRACT

Cathode compositions for use in lithium-ion cells and other metal-ion cells, which have a lithium compound or other metal compound additives, matching the selected chemistry of the cell, which additives eliminate irreversible capacity loss.

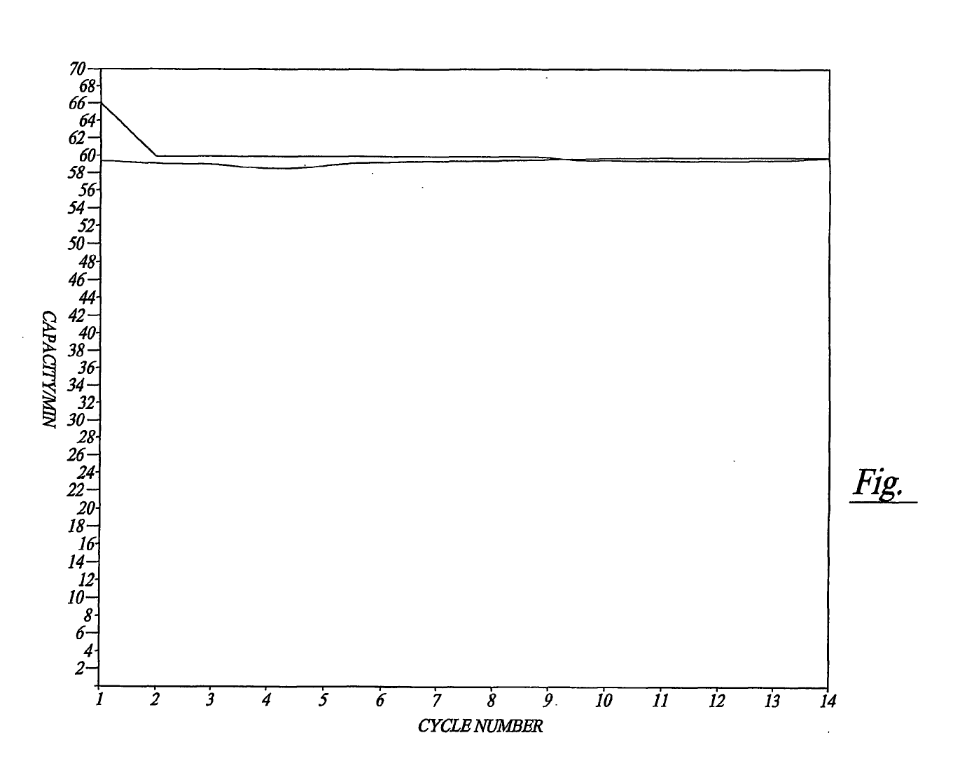

### BACKGROUND OF THE INVENTION

1. Field of the Invention

This invention relates to cathode compositions for lithium-ion cells and other metal ion cells which have a metal compound additive, to eliminate irreversible capacity loss.

2. Description of the Prior Art

Prior art cells and for example lithium-ion cells suffer from an irreversible capacity loss of about 10% during the first operating cycle, which is due to the formation of a passivation layer on the carbon anode surface. This phenomenon reduces the energy density of the cell.

Prior art patents addressing this problem propose various additives in the liquid electrolyte of the cell. These additives, for example, 2% vinylene carbonate or vinyl acetate create their own passivation layer on carbon, but the preferred additives are very expensive, and do not fully eliminate, but merely reduce the amount of irreversible capacity loss. Additionally, the prior art additives usually negatively affect the cycle life of the cell.

Another prior art patent proposes an extra 5% lithiation of manganese oxide spinel in a high temperature chemical process prior to fabricating the cathode; in which LiOH is mixed with MnO₂ and the LiOH is decomposed by heat, resulting in Li_{1.05}Mn₂O₄. The spinel is then used with a binder and carbon black to form the cathode electrodes of a lithium-on battery. The extra 5% of lithium is consumed for the anode passivation during the first cycle of the battery, leaving 100% capacity for the consequent cycling.

The disadvantage of this system is in the high cost of the heat energy consuming chemical process, and it is limited only to the manganese oxide spinel, since other known oxides do not accept the extra lithium into their crystalline structures, such as cobalt oxide or nickel oxide.

The addition of a lithium compound, such as a lithium carbonate additive to the cathode slurry composition, results in a composition, when formed into a cathode, that does not have an irreversible capacity loss, and provides many positive advantages not found in the prior art structures.

### SUMMARY OF THE INVENTION

It has now been found that complete elimination of the irreversible capacity loss of a lithium-ion cell can be readily achieved by admixing an inexpensive and lightweight lithium carbonate (Li₂CO₃), or other such lithium compound additive into any lithium based positive electrode (cathode) slurry or paste, before coating the slurry onto a substrate. The slurry may comprise, for example, a lithiated metal oxide (such as LiCoO₂, LiNiO₂, LiMn₂O₄, LiCoNiO₂, LiV₂O₅, etc.) or any lithiated cathodic material, carbon black, a binder, and optionally a solvent. The slurry is coated, or extruded and pressed onto a metal current collector substrate, and the solvent is evaporated if necessary, to form the cathode electrode, which may be used in a lithium-ion cell.

It has also been found, that the Li₂CO₃ and other lithium compounds decompose electrochemically in the cell upon charge. This extra lithium from the lithium compound replaces the lithium irreversibly lost in passivating the anode carbon surface, or any lithium-ion anode surface, and 100% of the lithium capacity from the lithiated cathode material is then available for cycling. The irreversible capacity loss is thus completely eliminated. The excess CO₂ by-product gas is vented out. Other metal compounds can be similarly used, matching the selected chemistry of the cell.

The principal object of the invention is to provide a cathode composition for lithium-ion cells and other metal-ion cells which eliminates the irreversible capacity loss.

A further object of the invention is to provide a cathode composition of the character aforesaid which is particularly suitable for economical mass production.

Other objects and advantageous features of the invention will be apparent from the description and claims.

### DESCRIPTION OF THE DRAWINGS

The nature and characteristic features of the invention will be more readily understood from the following description taken in connection with the accompanying drawings forming part hereof in which:

The FIGURE is a graph of tests of a cell having a cathode composition constructed in accordance with the invention.

It should, of course, be understood that the description and drawings herein are merely illustrative and that various modifications and changes can be made in the compositions disclosed without departing from the spirit of the invention.

### DESCRIPTION OF THE PREFERRED EMBODIMENTS

When referring to the preferred embodiments, certain terminology will be utilized for the sake of clarity. Use of such terminology is intended to encompass not only the described embodiment, but also technical equivalents which operate and function in substantially the same way to bring about the same result.

Lithium metal oxides such as lithium cobaltate, lithium manganate, lithium nickelate, or other related lithium transition metal oxides actually store or supply the reversible flow of lithium-ions during charging and discharging in a lithium-ion battery. However, the irreversible lithium loss from the cathode occurs on the initial charging cycle when it is lost in irreversibly passivating the anode.

Since a commercial cell (battery) is essentially balanced with respect to electrical equivalency of the cathode and anode material, the overall potential energy density of the battery is reduced approximately 10%.

The cathode composition to be described is useful in lithium-ion cells of well-known type, and eliminates the irreversible capacity loss of approximately 10% which results from the passivation layer formed by lithium on the carbon anode surface of the cell.

The cathode composition can be any lithium based positive electrode (cathode) slurry or paste to which the lithium compound additive is added prior to it being coated onto a metal current collector substrate to form a cathode electrode, and then used in a lithium ion cell.

Therefore if a lithium source which is compatible with the cell is added to the cathode and has a significantly higher lithium content by weight % than the active lithium metal oxide, a net gain of retained energy density and capacity results.

For example:

Lithium carbonate contains approximately 19% of lithium by weight.

Lithiated cobalt oxide (LiCoO₂) contains approximately 7% lithium by weight.

If 42, of LiCoO₂ is used in the slurry mix, the litliated cobalt oxide contains 2.94_{g} of lithium. (=7%)

The additional 10% of Li=approximately 0.3_{g} is supplied by adding 1.58_{g} of Li₂CO₃ to the slurry, (1.58×0 19=0.3) containing approximately 19% of lithium by weight. The additional 10% of lithium makes up for the irreversible lithium lost on the initial charge cycles.

The excess CO₂ by-product gas is vented out of the cell, during cycling, and/or the cell is repackaged and sealed.

An amount of Li₂CO₃ additive in the range molecularly equivalent to 2% to 40%, and preferably 10% of the lithium atoms contained in the cathode material should be added to the cathode mix prior to coating or formation of the cathode. This depends on the usual irreversible loss of the carbon type used in the anode, or other anodic material type used. Li₂CO₃ decomposes electrochemically in the cell upon initial charging.

After the excess CO₂ is vented out, only 0.7% % of the LiCoO₂ weight is added by this extra 10% of lithium, and it remains in the cell, which is a small weight increase for the benefit of a 10% capacity increase.

Lithium carbonate is of relatively low cost which also eliminates the need for expensive additives in the electrolytes.

This method can be applied with any lithium-ion cathode type to passivate any lithium-ion anode type, in a cell.

Of course, if less Li₂CO₃ than required is added to the positive electrode composition, then the irreversible capacity loss is only reduced, not eliminated. If more Li₂CO₃ is added than required, the added weight decreases the overall cell energy density. Lithium plating on the anode may also occur, which is dangerous and should be avoided. The cell electrodes should be therefore balanced, which means having approximately the same capacity.

Other cell compatible lithium compounds may be added to the cathode slurry to function as a lithium source for irreversible loss, providing that these sources have a lithium content substantially greater by weight % than the lithium metal oxide cathode material. In order to be practical, the compatible lithium compound should have a lithium content greater than 10% by weight. The amount of lithium compound to add should contain enough lithium to be approximately equivalent to the amount of lithium irreversibly lost by the lithium metal oxide component of the cathode. Useful range of addition of these lithium compounds is 0.1% to 10% by weight of slurry mix excluding solvent.

### EXAMPLE

The cathode slurry was prepared by mixing with a high speed stirrer for 1 hour in 110_{g} dimethoxyethane (DME) as a solvent, in a closed bottle and containing

| | | |
|---|---|---|
| 1. | 11.25 _{g} PVDF/HFP 2801 (Atofina) | 14.7% |
| 2. | 17.25 _{g} proprietary plasticizer | 22.5% |
| 3. | 42 _{g} LiCoO₂ (FMC) | 55% |
| 4. | 1.6 _{g} Li₂CO₃ (Lithchem) | 2% |
| 5. | 4.5 _{g} Super-P Carbon (Eurachem) | 5.8% |
| Total = | 76.6 _{g} | 100% |

The slurry, as described above, was used to construct a cathode electrode and the cathode electrode was used in a lithium-ion cell, activated by 1M LiPF₆ EC/DMC/EMC (1:1:1) electrolyte. The Li₂CO₃ is useful in the range from 0.1% to 10% by weight. The plasticizer can be also replaced by an electrolyte in the slurry.

The weight of the cathode electrode without the current collector was 0.80_{g} which at 55% loading by LiCoO₂ had 0.44_{g} of this active material therein. At 137 mAhg capacity of this material, the 100% expected capacity was 60 mAh. A MCMB (mesocarbon microbeads) based anode was sized and balanced to also accept the additional 10% of lithium (=6 mAh) upon charge, provided from the Li₂CO₃ in the cathode, which totaled 66 mAh. The cell was tested on MACCOR Tester, Model 2300 at C/5 rate and the capacity is illustrated in the FIGURE.

| Charge Cycle | Cap mAh | |
|---|---|---|
| 1^{st} charge | 66 mAh | |
| 1^{st} Disch. | 59 mAh | |
| 6^{th} charge | 60 mAh | |
| 6^{th} Disch. | 60 mAh | which is 100% of the expected cathode |

capacity of the cell

The subsequent cycles had abnormally shallow decline angle of the capacity curve, better than standard comparable cells without the Li₂CO₃ presence in the cathode. Li₂CO₃ presence also minimizes or reduce the capacity decline, which is an additional benefit.

This test was repeated with several cells with substantially the same results, and demonstrated that the Li₂CO₃ decomposes electrochemically, and that the balanced Li₂CO₃ addition to the cathode completely eliminates the irreversible capacity loss, and then minimizes the capacity decline.

Other lithium compounds can be similarly used, such as Li₂SO₃, LiF, Li₂O, Li₃N, lithium oxalate and their mixtures including Li₂CO₃ and provide similar results.

It should be noted, that this invention is not limited to lithium-ion cells. Other metal ion type cells may use other metal carbonates or other metal compounds matching the selected chemistry of the cell to eliminate irreversible loss, and/or to reduce capacity decline. For example: sodium-ion cell would use similarly sodium carbonate, or

other sodium compounds like Na₂SO₃, NaF, Na₂O, Na₃BO₃ including their mixtures and provide similar results.

It will thus be seen that cathode compositions have been provided with which the objects of the invention are achieved.

We claim:

1. A cathode composition for use in the cathode of lithium-ion cells, which has a lithiated cathode material and a lithium compound additive therein, and said additive reduces or eliminates irreversible capacity loss of said cells.

2. A cathode composition for use in the cathode of lithium-ion cells which has a lithiated cathode material and a lithium compound additive therein, which additive is selected from a group comprising: lithium carbonate, lithium sulfite, lithium oxide, lithium nitride, lithium borate, lithium boride, lithium fluoride, lithium oxolate, and their mixtures.

3. A cathode composition as defined in claim 1 or 2 in which said lithium compound additive is present in the range of 0.1% to 10% by weight.

4. A cathode composition as defined in claim 1 in which, said cathode composition includes:
a. Polyvinylidene Fluoride/Hexafluoropropylene
b. Plasticizer or an electrolyte
c. LiCoO₂
d. Li₂CO₃
e. Super-P carbon

5. A cathode composition as defined in claim 1 or 2 in which said composition contains a lithium compound additive in the range molecularly equivalent to 2% to 40% of the lithium ions contained in the lithiated cathode material.

6. A cathode composition for lithium-ion cells as described in claim 1, in which said lithium compound additive contains more than 10% of lithium by weight.

7. A cathode composition for metal-ion cells, which has a metal compound additive and said additive reduces or eliminates irreversible capacity loss of said cells.

8. A cathode composition for metal-ion cells, which has a metal compound additive, which is selected from a group comprising:
Na₂CO₃, Na₂SO₃, Na₂O, Na₃BO₃, and NaF, and their mixtures.

9. A lithium-ion cell which includes a composite cathode having a composition as described in clams 1, or 2, or 3, or 4, or 5, or 6.

10. A lithium-ion cell as described in claims 1 to 6, which has balanced electrical capacities of electrodes.

11. A metal-ion cell which includes a composite cathode having a composition as described in claims 7, or 8.

12. A metal-ion cell as described in claims 7, or 8, which has balanced electrical capacities of electrodes.
